(19) United States
(12) Patent Application Publication
(10) Pub. No.: US 2008/0254269 A1
(43) Pub. Date: Oct. 16, 2008

(54) NbO Capacitors With Improved Performance And Higher Working Voltages

(76) Inventors: Yuri Freeman, Greer, SC (US); Philip M. Lessner, Newberry, SC (US); Jeffrey Poltorak, Fountain Inn, SC (US); Randolph S. Hahn, Simpsonville, SC (US)

Correspondence Address: NEXSEN PRUET, LLC, P.O. BOX 10648, GREENVILLE, SC, 29603, US

(21) Appl. No.: 12/062,738

(22) Filed: Apr. 4, 2008

Related U.S. Application Data
(60) Provisional application No. 60/923,422, filed on Apr. 13, 2007.

(51) Int. Cl. B32B 9/00; B32B 7/02; B05D 5/12

(52) U.S. Cl. 428/218; 428/702; 427/79

(57) ABSTRACT

A capacitor is described with an NbO anode. The capacitor has an NbO anode and an NbO anode lead extending from the NbO anode. A dielectric is on the NbO anode and a conductor is on the dielectric.

### CROSS-REFERENCE TO RELATED APPLICATIONS

This application claims priority to U.S. Provisional Appl. No. 60/923,422 filed Apr. 13, 2007 which is pending and incorporated herein by reference.

### BACKGROUND OF THE INVENTION

This invention relates to a method for manufacturing NbO electrolytic capacitors, and capacitors formed thereby, with improved performance and an extended range of working voltages.

Electrolytic capacitors containing anodes made from niobium oxides and sub-oxides (typically NbO) were first described by James Fife in U.S. Pat. No. 6,416,730. These anodes were made by placing a lead wire into NbO powder and pressing the powder into a pellet. The pellets were then sintered, preferably, in a vacuum. The lead wire, which forms the anode termination, is typically made of Ta or Nb wire. Subsequent steps of manufacturing of NbO capacitors are similar to the Ta capacitors. They include formation of dielectric film by anodizing the NbO pellet, impregnation of the formed anode with a MnO₂ cathode, top-coating with carbon and silver, assembly, and testing. The advantages of NbO capacitors relative to Ta capacitors include availability of raw materials and a non-burning failure mode. The non-burning failure mode is believed to be due to the fact that NbO has 50% oxygen, stoichiometrically, which makes the igniting energy much higher than that of Ta. Furthermore, after electrical breakdown NbO capacitors have 100 ohm to 1000 ohm residual resistance while Ta and Nb capacitors are typically shorted after electrical breakdown. In comparison to wet Al capacitors, NbO capacitors have higher volumetric efficiency, higher reliability, lower ESR, and better thermal stability of AC characteristics.

The disadvantages of NbO capacitors versus Ta capacitors are lower working voltages, higher DC leakage, lower volumetric efficiency, and higher ESR for a given case size. Higher ESR is caused by lower conductivity of NbO in comparison to conductivity of typical metals like Ta, Nb and Al.

In the prior art, where either Ta or Nb wire are used as the anode lead, oxygen diffusion from NbO powder into the wire takes place during sintering of NbO powder. The driving force for this diffusion is a large difference in oxygen content between NbO, which is about 50% atomic oxygen, and Nb or Ta, which is below about 2% atomic oxygen. Oxygen diffusion increases exponentially with temperature and is very active at the sintering temperature of NbO powder which may exceed about 1200° C. As a result of this diffusion, Ta or Nb wire becomes enriched with oxygen. Adjacent to the wire area NbO powder becomes depleted of oxygen. Calculations described in B. Boiko, Y. Pozdeev, et al., Thin Solid Films, 130 (1985) 341, using oxygen diffusion parameters, suggest that depletion of oxygen in NbO powder during sintering results in its transformation into Nb saturated with oxygen in a layer about 10 μm thick surrounding the wire.

The amorphous dielectric film formed on oxygen saturated Nb is highly susceptible to crystallization (Y. Pozdeev Freeman, Mat. Res. Symp. Proc., 788 (2004) 109). When crystals grow in an amorphous matrix of dielectric they eventually disrupt the dielectric field due to mechanical stress caused by differences in specific volume of amorphous and crystalline phases. As a result of disruption of the dielectric, DC leakage increases. Thicker dielectrics in higher working voltage capacitors suffer more from the crystallization which limits the working voltage available in NbO capacitors. Furthermore, higher working voltages require coarse powder and higher sintering temperature. The latter stimulates growth of the oxygen saturated Nb layer around the wire, which makes crystallization of the dielectric even more severe.

Through diligent research the present inventors have developed a method for mitigating the deficiencies of a NbO capacitor thereby allowing the anticipated advantages to be fully exploited. The present invention solves a long standing problem in the art which was previously not understood and for which a solution was lacking.

### SUMMARY OF THE INVENTION

It is an object of the present invention to provide an improved capacitor.

A particular object of the present invention is to provide a capacitor utilizing an NbO anode wherein the problems associated with an NbO anode, as realized in the art, are mitigated.

A particular advantage of the present invention is the ability to provide a capacitor comprising an NbO anode utilizing conventional manufacturing equipment thereby allowing the cost advantages of NbO relative to Ta to be realized without compromise.

These and other advantages, as will be realized, are provided in a capacitor. The capacitor has an NbO anode and an NbO anode lead extending from the NbO anode. A dielectric is on the NbO anode and a conductor is on the dielectric.

Yet another embodiment is provided in a capacitor with an NbO anode. A knob comprising NbO is attached to the NbO anode wherein the knob may have a density which is higher than a density of the NbO anode. An anode lead is attached to the knob and a dielectric is on the NbO anode. A conductor is on the dielectric.

Yet another embodiment is provided in a process of manufacturing a capacitor comprising:

providing an NbO anode with an NbO anode lead extending therefrom; forming a dielectric on the NbO anode; and
forming a conductor on the dielectric.

Yet another embodiment is provided in a process of manufacturing a capacitor comprising:

providing a sintered NbO anode comprising a sintered knob attached thereto wherein the knob comprises NbO;
attaching an anode lead to the knob;
forming a dielectric on the NbO anode; and
forming a conductor on the dielectric.

### SUMMARY OF THE FIGURES

FIG. 1 is a cross-sectional schematic view of an embodiment of the present invention.

FIG. 2 is a cross-sectional schematic view of an embodiment of the present invention.

FIG. 3 illustrates a method of forming a capacitor in accordance with the present invention in flow chart representation.

FIG. 4 illustrates a method of forming a capacitor in accordance with the present invention in flow chart representation.

### DETAILED DESCRIPTION OF THE INVENTION

The present invention provides a method of forming a capacitor, and capacitor formed thereby, wherein an anode lead comprising NbO is utilized thereby mitigating the effects of oxygen migration which occur during sintering. In an alternative embodiment a higher density NbO stud is attached to the surface of the anode prior to sintering and an anode lead is embedded into the NbO stud.

The invention will be described with reference to the figures forming an integral, non-limiting, part of the disclosure. Throughout the various figures similar elements will be numbered accordingly.

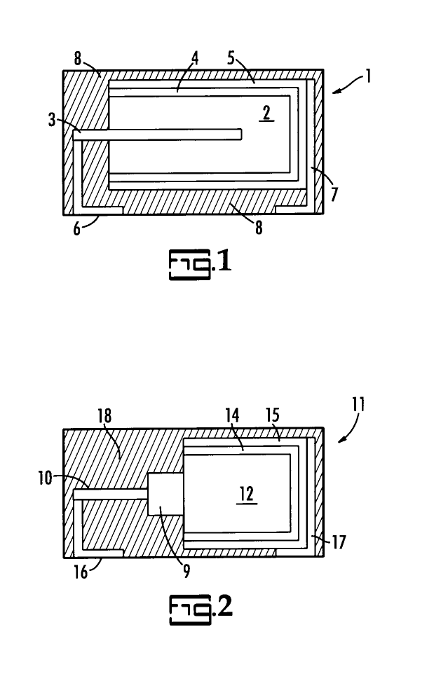

An embodiment of the present invention is illustrated in cross-sectional schematic view in FIG. 1. In FIG. 1 a capacitor, generally represented at 1, comprises an anode, 2, of pressed and sintered NbO. An NbO anode lead, 3, extends from the interior of the anode and is in intimate contact with the anode. The intimate contact is preferably established by pressing the anode powder around the NbO anode lead. A NbO lead can be attached to the NbO anode, by welding for example, but this is less desirable. A dielectric layer, 4, is on the surface of the anode, The dielectric layer may be on multiple surfaces of the anode and may be circumjacent to the anode. A cathode layer, 5, is on the surface of the dielectric and separated from the anode by the dielectric. The cathode layer may be on multiple surfaces of the dielectric with the understanding that the cathode and anode are not in direct electrical contact since this would create an electrical short thereby rendering the capacitor useless. An anode termination, 6, is in electrical contact with the anode lead and extends to the exterior of the capacitor thereby allowing the anode termination to form contact with an electrical circuit element. A cathode termination, 7, is in electrical contact with the cathode layer and extends to the exterior of the capacitor thereby allowing the cathode termination to form a contact with an electrical circuit element. The entire capacitor, except for a portion of the anode termination and cathode termination, is preferably encased in an electrically non-conductive material, 8, preferably a non-conductive polymer, thereby prohibiting the capacitor from inadvertent electrical contact.

Another embodiment of the present invention is illustrated in cross-sectional schematic view in FIG. 2. In FIG. 2 the capacitor, generally represented at 11, comprises an NbO anode, 12. A dielectric, 14, is on the surface of the anode as described supra relative to FIG. 1. A cathode, 15, and associated cathode lead, 17, are provided as described supra relative to FIG. 1. A high density NbO stud, 9, is adhered to a surface of the NbO anode. The high density NbO stud is preferably formed by co-pressing and co-sintering the stud and anode, however, the high density NbO stud and NbO anode can be pressed and sintered separately and joined by a conductive adhesive or by welding. Co-pressing and co-sintering is preferred. An anode lead, 10, is attached to the high density NbO stud preferably by embedding and sintering. The anode lead is preferably Nb, Ta or an alloy thereof. An anode termination, 16, is attached to the anode lead and the capacitor is preferably encased in a non-conductive polymer, 18.

It is preferable that the knob have a higher density than the anode. The higher density decreases resistance in the knob and provides improved adhesion to the anode lead. It is preferable that the density of the anode be at least about 2.5 g/cc to no more than about 4.5 g/cc. It is preferable that the density of the knob be at least about 2.8 g/cc to no more than about 5 g/cc. It is preferable that the density of the knob is at least 12% higher than the density of the anode.

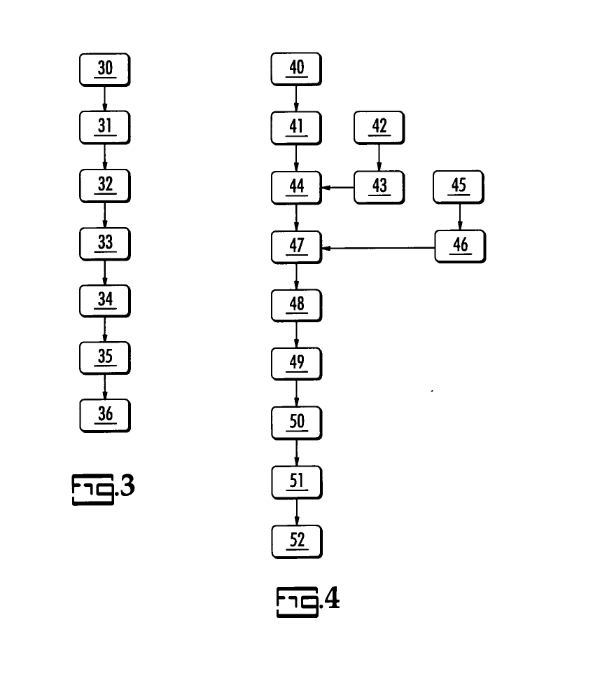

An embodiment of the present invention is illustrated in flow chart representation in FIG. 3. In FIG. 3 a NbO anode lead is inserted into an NbO powder at 30. The powder is pressed at 31, thereby embedding the NbO anode lead into the pressed NbO powder thereby forming an anode precursor with NbO anode lead extending therefrom. The anode precursor is heated to a temperature sufficient to sinter the anode at 32 thereby forming a sintered NbO anode with anode lead extending therefrom. A dielectric is formed on at least one surface of the NbO anode at 33. A particularly preferred dielectric is nominally Nb₂O₅. A cathode is formed on the surface of the dielectric at 34. Anode termination is attached to the NbO anode lead and a cathode termination is attached to the cathode lead at 35 thereby forming a leaded capacitor. The leaded capacitor is preferably encased in a non-conductive material at 36 with the exception of some portion of the anode lead and cathode lead which is preferably exposed for attachment to electrical circuitry.

Embodiments of the present invention are illustrated in flow chart representation in FIG. 4. In FIG. 4, NbO powder is provided at 40. The NbO powder is pressed at 41 into an anode. In a parallel process NbO powder is provided at 42 and pressed into a knob at 43. The knob preferably has a higher density than the anode. The knob is then attached to the anode at 44 thereby forming an anode with a high density knob attached thereto. In an alternative embodiment NbO powder is provided at 45 and pressed at 46 in a manner sufficient to form an anode with a higher density knob pressed therewith to form an anode with a high density knob attached thereto. The pressing may be concurrent or sequential. The anode with a high density knob is sintered at 47 to form a sintered anode with a sintered high density knob attached thereto. In one embodiment the anode and high density knob may be sintered separately and then combined by attaching the knob to the anode but this is not preferred. An anode lead is attached to the high density knob at 48, preferably by embedding and sintering. The anode lead is preferably Ta, Nb or an alloy thereof. A dielectric is formed on the anode at 49. A particularly preferred dielectric is oxygen saturated Nb which is nominally Nb₂O₅. A cathode is formed on the surface of the dielectric at 50. Anode termination is attached to the NbO anode lead and a cathode termination is attached to the cathode lead at 51 thereby forming a leaded capacitor. The leaded capacitor is preferably encased in a non-conductive material at 52 with the exception of some portion of the anode lead and cathode lead which is preferably exposed for attachment to electrical circuitry.

The process of this invention provides improved performance and higher working voltages to NbO capacitors. To achieve these goals, the part of the anode lead wire in contact with the active capacitor area comprises NbO.

For the purposes of the present invention Nb and Ta refer to a material with no more than about a 2% stoichiometric amount of oxygen and more preferably less than 1% stoichiometric amount of oxygen.

For the purposes of the present invention NbO used in the lead is a homogeneous NbO with stoichiometry of Nb₁₊ₓO₁₋ₓ wherein −0.1≦x≦0.1, and more preferably −0.01≦x≦0.01. Most preferably NbO is a pure material with even stoichiometry.

For the purposes of the present invention NbO used in the anode is a homogeneous NbO with stoichiometry of Nb_{1+y}O_{1-y} wherein −0.1≦y≦0.1, and more preferably −0.01≦y≦0.01. Most preferably NbO is a pure material with even stoichiometry.

For the purposes of the present invention the term homogenous refers to a material with less than 10% variation in stoichiometric ratio of metal and oxygen throughout the material.

In one embodiment NbO wire, or strips, are embedded into a NbO powder prior to pressing into a pellet. In this embodiment the capacitor is formed in a manner directly analogous to Ta and Nb capacitors with the exception of the materials used.

The cross-sectional shape of the anode lead, or NbO anode lead is not particularly limited herein. Round, obround, oblong and elliptical are preferred due to the improved contact between the pressed powder and lead. Other shapes, such as polygonal shapes, are suitable but less desirable. It is preferred that the anode lead, or NbO anode lead, have a aspect ratio of greater than 1 wherein the aspect ratio is the ratio of lengths of orthogonal cross-sectional lengths.

While not limited to any theory, it is postulated that the lack of an appreciable oxygen gradient between the anode and anode lead minimizes oxygen diffusion between sintered NbO powder and an NbO lead during sintering. The dielectric film formed by anodizing the NbO surface is less prone to crystallization as it is in the case of Nb saturated with oxygen. This prevents disruption of the dielectric created by crystal growth and mitigate DC leakage and increases working voltage of an NbO capacitor. Moreover, the interface between NbO anodes and Nb₂O₅ dielectric is thermodynamically more stable than an interface between Nb and Nb₂O₅. The more stable dielectric limits oxygen migration from the dielectric into the anode thereby also reducing DC leakage and increasing the working voltage of NbO capacitors.

Another advantage of the present invention is the ability to use conductive polymer as the cathode material thereby reducing ESR of the NbO capacitors. Conductive polymers are not solid electrolytes and can not provide the same self-healing effect to the dielectric as MnO₂ cathode. When conductive polymers are used with NbO anodes with Ta or Nb lead wire, which have a high density of defects in dielectric in vicinity of the lead wire, DC leakage is very high. When NbO anodes are manufactured according to this invention, they have low density of defects in the dielectric thereby allowing full utilization of the advantages offered by a conductive polymer cathode. These NbO capacitors have lower and more stable DC leakage, lower ESR, and higher working voltages in comparison to the NbO capacitors manufactured according to the prior art.

The cathode is a conductor preferably comprising at least one of manganese dioxide, a conductive polymeric material or a liquid electrolyte. Particularly preferred conductive polymers include polypyrrole, polyaniline and polythiophene. Metals can be employed as a cathode material with valve metals being less preferred. The cathode may include multiple layers wherein adhesion layers are employed to improved adhesion between the conductor and the termination. Particularly preferred adhesion layers include carbon, silver, copper, or another conductive material in a binder.

The dielectric is a non-conductive layer which is not particularly limited herein. The dielectric may be a metal oxide or a ceramic material. A particularly preferred dielectric is the oxide of the anode due to the simplicity of formation and ease of use. Nb₂O₅ is the most preferred dielectric.

The invention has been described with particular reference to the preferred embodiments without limit thereto. Other embodiments, alterations and extensions will be realized which are within the scope of the invention which is more specifically set forth in the claims appended hereto.

Claimed is:

1. A capacitor comprising:
an NbO anode;
an NbO anode lead extending from said NbO anode;
a dielectric on said NbO anode; and
a conductor on said dielectric.

2. The capacitor of claim 1 wherein said NbO anode comprises Nb_{1+y}O_{1-y} wherein −0.1≦y≦0.1.

3. The capacitor of claim 1 wherein said NbO anode lead comprises Nb₁₊ₓO₁₋ₓ wherein −0.1≦x≦0.1.

4. The capacitor of claim 1 wherein said dielectric comprises Nb₂O₅.

5. The capacitor of claim 1 wherein said conductor comprises at least one material selected from MnO₂, a conductive polymer and a liquid electrolyte.

6. The capacitor of claim 5 wherein said conductive polymer is selected from the group consisting of polypyrrole, polyaniline and polythiophene.

7. The capacitor of claim 1 further comprising at least one element selected from an anode lead in electrical contact with said NbO anode lead and a cathode lead in electrical contact with said cathode.

8. A capacitor comprising:
an NbO anode;
a knob comprising NbO attached to said NbO anode;
an anode lead attached to said knob;
a dielectric on said NbO anode; and
a conductor on said dielectric.

9. The capacitor of claim 8 wherein said knob has a density which is higher than a density of said NbO anode.

10. The capacitor of claim 9 wherein said NbO anode has a density of 2.5 g/cc to 4.5 g/cc and said knob has a density of 2.8 g/cc to 5 g/cc.

11. The capacitor of claim 9 wherein said knob has a density which is at least 12% higher than a density of said anode.

12. The capacitor of claim 8 wherein said NbO anode comprises Nb_{1+y}O_{1-y} wherein −0.1≦y≦0.1.

13. The capacitor of claim 8 wherein said anode lead comprises a material selected from Nb and Ta.

14. The capacitor of claim 8 wherein said dielectric comprises Nb₂O₅.

15. The capacitor of claim 8 wherein said conductor comprises at least one material selected from MnO₂, a conductive polymer and a liquid electrolyte.

16. The capacitor of claim 15 wherein said conductive polymer is selected from the group consisting of polypyrrole, polyaniline and polythiophene.

17. The capacitor of claim 8 wherein said anode and said knob have a density of 2.5 g/cc to 5 g/cc.

18. The capacitor of claim 8 further comprising at least one element selected from an anode lead in electrical contact with said anode lead and a cathode lead in electrical contact with said cathode.

19. A process of manufacturing a capacitor comprising:
providing an NbO anode with an NbO anode lead extending therefrom;
forming a dielectric on said NbO anode; and
forming a conductor on said dielectric.

20. The process of manufacturing a capacitor of claim 19 wherein said NbO anode comprises Nb_{1+y}O_{1-y} wherein −0.1≦y≦0.1.

21. The process of manufacturing a capacitor of claim 19 wherein said NbO anode lead comprises Nb₁₊ₓO₁₋ₓ wherein −0.1≦x≦0.1.

22. The process of manufacturing a capacitor of claim 19 wherein said dielectric comprises Nb₂O₅.

23. The process of manufacturing a capacitor of claim 19 wherein said conductor comprises at least one material selected from MnO₂, a conductive polymer and a liquid electrolyte.

24. The process of manufacturing a capacitor of claim 23 wherein said conductive polymer is selected from the group consisting of polypyrrole, polyaniline and polythiophene.

25. The process of manufacturing a capacitor of claim 19 further comprising at least one element selected from attaching an anode lead in electrical contact with said NbO anode lead and attaching a cathode lead in electrical contact with said cathode.

26. A process of manufacturing a capacitor comprising:
providing a sintered NbO anode comprising a sintered knob attached thereto wherein said knob comprises NbO;
attached an anode lead to said knob;
forming a dielectric on said NbO anode; and
forming a conductor on said dielectric.

27. The process of manufacturing a capacitor of claim 26 further comprising providing a NbO powder and pressing said NbO powder to form an anode.

28. The process of manufacturing a capacitor of claim 27 further comprising providing a NbO powder and pressing said NbO powder to form said knob.

29. The process of manufacturing a capacitor of claim 26 wherein said anode and said knob are pressed separately.

30. The process of manufacturing a capacitor of claim 26 wherein said sintered NbO anode and said sintered knob are sintered separately.

31. The process of manufacturing a capacitor of claim 26 wherein said sintered NbO anode and said sintered knob are sintered together.

32. The process of manufacturing a capacitor of claim 26 wherein said NbO anode comprises Nb_{1+y}O_{1-y} wherein −0.1≦y≦0.1.

33. The process of manufacturing a capacitor of claim 26 wherein said NbO anode lead comprises Nb₁₊ₓO₁₋ₓ wherein −0.1≦x≦0.1.

34. The process of manufacturing a capacitor of claim 26 wherein said dielectric comprises Nb₂O₅.

35. The process of manufacturing a capacitor of claim 26 wherein said conductor comprises at least one material selected from MnO₂, a conductive polymer and a liquid electrolyte.

36. The process of manufacturing a capacitor of claim 35 wherein said conductive polymer is selected from the group consisting of polypyrrole, polyaniline and polythiophene.

37. The process of manufacturing a capacitor of claim 26 further comprising at least one element selected from attaching an anode lead in electrical contact with said NbO anode lead and attaching a cathode lead in electrical contact with said cathode.
